(19) United States
(12) Patent Application Publication
(10) Pub. No.: US 2024/0017410 A1
(43) Pub. Date: Jan. 18, 2024

(54) Robotic System Trajectory Planning

(71) Applicant: ABB Schweiz AG, Baden (CH)

(72) Inventors: Nima Enayati, Mannheim (DE); Arne Wahrburg, Weiterstadt (DE); Debora Clever, Zwingenberg (DE); Mikael Norrlöf, Norrköping (SE); Giacomo Spampinato, Västerås (SE); Mattias Björkman, Västerås (SE)

(73) Assignee: ABB Schweiz AG, Baden (CH)

(21) Appl. No.: 18/473,453

(22) Filed: Sep. 25, 2023

Related U.S. Application Data
(63) Continuation of application No. PCT/EP2021/057737, filed on Mar. 25, 2021.

(51) Int. Cl. B25J 9/16

(52) U.S. Cl. CPC B25J 9/1664; B25J 9/1682

(57) ABSTRACT

A method for trajectory planning in a robotic system comprising at least two robotic units includes a state vector of each robotic unit, which comprises position components and velocity components and is variable with time and independently from input into every other robotic unit. A trajectory defines the motion of said robotic units from an initial state to a final state and is determined by finding the trajectory that minimizes a predetermined cost function. The cost function is set to be a function of the state vectors of all robotic units, and is minimized under a constraint which defines a vector difference between at least the position components of the state vectors of said robotic units at an instant of said trajectory.

### CROSS-REFERENCE TO RELATED APPLICATIONS

The instant application claims priority to International Patent Application No. PCT/EP2021/057737, filed Mar. 25, 2021, which is incorporated herein in its entirety by reference.

### FIELD OF THE DISCLOSURE

The present disclosure generally relates to systems and methods for trajectory planning for a robotic system.

### BACKGROUND OF THE INVENTION

Mass customization and higher operational efficiency are important requirements of many modern discrete automation applications. Towards that end, increasingly higher flexibility and agility is demanded in various components of the production chain, from the factory floor to logistics. Using robotic vehicles to move parts among cells is a concept that can increase the flexibility of the production cycle, as less fixed automation setups such as conveyor belts would be required.

In a production environment where robotic units cooperate with e.g. conveyor belts, operation planning for a robot can be based on some immutable assumptions. Operation of the conveyor belt will determine, for all robotic units working on it, when and where a workpiece becomes available, and when work on it must be finished; so that a trajectory that meets these requirements can be planned for each robotic unit substantially without having regard to the others.

Of course, when such a conveyor belt is replaced by robotic vehicles, a straightforward approach would be to treat these similar to a conveyor belt, by defining a priori a path which the vehicles are supposed to follow, locations along the path where interaction with another robotic unit, such as a manipulator, is to take place, and to derive therefrom trajectories of the robotic units. It is obvious, though, that in that way, most of the potential for efficiency improvement that might come with the use of robotic vehicles will be lost.

### BRIEF SUMMARY OF THE INVENTION

The present disclosure describes a method for trajectory planning in a robotic system capable of providing trajectories for interacting robotic units that requires no a priori simplification and is therefore capable of finding a truly optimal or, at least, closer to optimal solution.

In one embodiment, a method for trajectory planning in a robotic system comprising at least two robotic units is described, wherein a state vector of each robotic unit comprises position components and velocity components and is variable with time as a function of input into said each robotic unit and independently from input into every other robotic unit, wherein a trajectory which defines the motion of said robotic units from an initial state to a final state is determined by minimizing a predetermined cost function, characterized in that the cost function is a function of the state vectors of all of said at least two robotic units, and is minimized under a constraint which defines a vector difference between at least the position components of the state vectors of said robotic units at an instant of said trajectory.

The constraint ensures that while the robotic units follow their respective trajectories, there is an instant where their respective positions enable an interaction between them. Reference points of the two robotic units can be chosen so that the difference is zero, but this isn't a requirement. The interaction can be of any type, such as handing over a workpiece from one unit to the other, or one unit processing a workpiece mounted on the other.

The instant where the interaction takes place can be at the end of the respective trajectories. This doesn't imply an a priori assumption on the location where the interaction will take place; it merely implies that trajectories of the units from their respective starting point to their interaction point will be optimized under the criteria embodied in the cost function, whereas trajectories after the interaction will not.

Alternatively, both the initial and the final state of the trajectories may be predetermined, and the instant when interaction takes place is determined by minimization of the cost function.

Since operations in a production environment are mostly repetitive, an optimization spanning the entire operation of the robotic units can be achieved by setting identical state vectors of the robotic units at the beginning and at the end of their respective trajectories.

The difference mentioned above can be a difference also of velocity components of the state vectors of the robotic units. In this way, it can be ensured that the robotic units not only come into close enough contact for interaction, but that they stay close enough to each other—even if both are in motion—for a sufficiently long time for the interaction to take place, and that they do not bump into each other.

Typically, at least one of the robotic units is a vehicle, which can be used for conveying workpieces. Such a vehicle may be ground- or airborne.

Another robotic unit, used for effecting some change on the workpieces, will typically be a manipulator, comprising, e.g., an articulated robot arm or a gantry type robot.

The cost function can be designed to increase along with one or more of the following parameters:
time needed for executing the trajectory,
total energy required for executing the trajectory,
peak power required when executing the trajectory,
load imposed on each one of actuators of the robotic units when executing the trajectory;
if the robotic unit is battery-powered, in particular if it is a vehicle, the degree of exhaustion of a battery of the robotic unit.

A cost function dependent on load may be designed to merely prevent the planning of movements which the robot might be incapable of carrying out because they exceed its physical limitations. Preferably, the cost assigned to a particular movement will model its effect on expected lifetime of the robot, so that by minimizing that cost function, the trajectory that will be chosen is the one where wear of the robot is least.

A cost function dependent on battery exhaustion will help to avoid planning movements, which might harm the battery by excessively discharging it, or which might not be carried out in time because the battery, when nearly exhausted, cannot provide the power necessary for carrying out the movement at an adequate speed.

Typically, the cost function will be a weighted sum of addends, each of which depends on one of the above-mentioned parameters. In the cases of time and total energy, the added should be directly proportional to its associated parameter. In the cases of peak power and load, the addend might also be a step function or some other kind of function that increases sharply when some given threshold is exceeded, so that the solution to the minimization problem will never or only under exceptional circumstances exceed this threshold.

Further features and advantages of the invention will become apparent from the subsequent description of embodiments, referring to the appended drawings.

### BRIEF DESCRIPTION OF THE SEVERAL VIEWS OF THE DRAWING(S)

FIG. 1 is a diagram of an exemplary robotic system in accordance with the disclosure.

FIG. 2 is a flowchart of a method for planning trajectories in the system of FIG. 1.

### DETAILED DESCRIPTION OF THE INVENTION

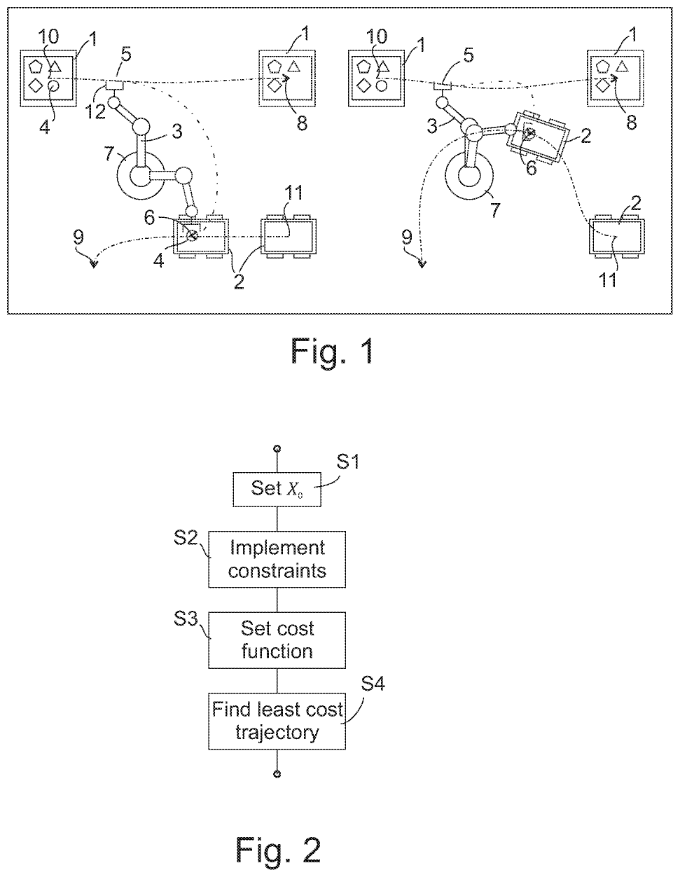

FIG. 1 is a schematic diagram of part of a production line. What is shown are two vehicles 1, 2 and an articulated manipulator 3. Representations of these in solid lines and in dashed lines correspond to different stages of their respective trajectories. The task to be executed by the manipulator 3 is to pick a workpiece 4 from vehicle 1 and to place it on vehicle 2 using a gripper 12 at a distal end of the manipulator. As an example, it shall be assumed that both vehicles 1, 2 have equal maximum velocity, and vehicle 1 has a larger mass and higher friction and thus higher energy consumption than vehicle 2, and that the maximum velocity of the manipulator 3 is higher than that of the vehicles 1, 2.

When the operation of vehicles 1, 2 and manipulator 3 is optimized for minimum time, the result may look as shown in the left-hand half of FIG. 1: Vehicle 1 follows a substantially straight path. Workpiece 4 is picked from vehicle 1 at a location 5 where the distance of vehicle 1 to the manipulator 3 is smallest. Since the manipulator is faster than the vehicles, it is assigned a rather long path, a location 6 where the workpiece 4 is placed on vehicle 2 being farther away from location 5 than the stationary base 7 of manipulator 3, and the path of vehicle 2 being substantially straight, too.

On the other hand, energy efficiency of the manipulator 3 for transporting workpieces is less than that of the vehicles 1, 2. Therefore, when the procedure is optimized for total energy consumption, as shown in the right-hand half of FIG. 1, the path of the manipulator 3 between pick and place locations 5 and 6 will be shorter than in the case considered before. For vehicle 1, being heavy, any deviation from a straight, constant speed trajectory, would come at a high expense of energy; therefore, the pick location 5 is only slightly deviated towards base 7 unchanged, and lighter vehicle 2 has to make a detour in order to compensate for the shortened path of the manipulator 3.

Let us now consider the problem of finding a trajectory to be followed by the vehicles 1, 2 and the manipulator 3. It will be assumed here that the manipulator 3 comprises an articulated arm of conventional type, having a plurality nv, preferably nv≥6, degrees of rotational freedom. We assume the dynamics of the manipulator 3 to be governed by the Lagrangian equation of motion for rigid bodies:

\ddot{q}=(q)⁻¹(−C(q,\dot{q})−G(q)—c_{fric}\dot{q}+τₘₒₜₒᵣ) (1)

where M, C, and G, represent the mass matrix, Coriolis and centrifugal torques and gravity torques respectively, q is the joint configuration as a nv×1 vector, and τₘₒₜₒᵣ is a vector representative of torques generated by the motors associated to each of the nv degree of freedom of the manipulator 3.

Each vehicle 1, 2 is modelled as a point-mass:

\ddot{p}=m₋₁(−d_{fric}\dot{p}+f_{drive}) (2)

where m is the mass of the vehicle, p is the position vector of the vehicle, and f drive is a vector of representative of a force generated by a drive motor of the vehicle. In the case considered here, with the vehicles 1, 2 moving on a level floor, these vectors can be assumed to be two-dimensional; if vertical movements have to be considered, e.g., because the floor on which the vehicles move has sloped portions, a generalization to three-dimensional vectors is straightforward. Friction can be regarded as simply viscous, i.e., coefficients c_{fric}, d_{fric} can be regarded as constant and independent of \dot{q} or \dot{p}, respectively, but more sophisticated friction effects can easily be taken account of by modelling one or more of the friction coefficients as a function of some appropriate parameter.

Positions and velocities of all robotic units involved in the trajectory finding problem can be combined into a state vector X descriptive of the entire system:

X:=[x₁,x₂,x₃,x₄]=[q,\dot{q},p,\dot{p}]^{T},

where x₁ combines all Cartesian position components of the vehicles 1, 2, i.e., four components corresponding to coordinates in the floor plane of vehicles 1, 2, x₂ is the time derivative of x₁, x₃ combines the nv angular coordinates of manipulator 3, and x₄ is the time derivative of x₃. Of course, the state vector may comprise further components as required, e.g., higher derivatives of the position coordinates,

Input into the system is similarly described by a vector in which torques of the motors of manipulator 3 and drive forces of the motors of vehicles 1, 2 are combined:

U:=[u₁,u₂]=[τₘₒₜₒᵣ,f_{drive}]^{T}.

The continuous optimization problem is therefore defined as:

$${minimize}_{X , U} J , s . t . \qquad ( 3 )$$

$${\dot{x}}_{1} = {x}_{2} ,$$

$${\dot{x}}_{2} = {M ( {x}_{1} )}^{- 1} ( - C ( {x}_{1} , {x}_{2} ) - G ( {x}_{1} ) - {τ}_{fric} ( {x}_{2} ) + u ) ,$$

$${\dot{x}}_{3} = {x}_{4}$$

$${\dot{x}}_{4} = {m}^{- 1} ( - {d}_{fric} {x}_{4} + {f}_{actuator} )$$

$${q}_{min} \leq {x}_{1} \leq {q}_{max} ,$$

$$- {\dot{q}}_{max} \leq {x}_{2} \leq {\dot{q}}_{max} ,$$

$$- {v}_{max} \leq {x}_{4} \leq {v}_{max} ,$$

$$- {τ}_{max} ( {x}_{2} ) \leq {u}_{1} \leq {τ}_{max} ( {x}_{2} ) ,$$

$$- {f}_{max} ( {x}_{2} ) \leq {u}_{2} \leq {f}_{max} ( {x}_{2} ) ,$$

$${p}_{fk} ( {x}_{1}^{f ( i )} ) - {x}_{3 ( i )}^{f ( i )} = 0 , i = 1 , 2$$

wherein J stands for a cost function that is to be minimized, the first four equations correspond to equations (1), (2) and the definitions of x₂ and x₄ given above, the next two are limitations of coordinates and their derivatives imposed by design limitations of the vehicles 1, 2 and the manipulator 3, the next two impose limits on inputs u₁, u₂ which may depend on configurations x₁, x₂ of their associated robotic units, and the last one imposes boundary conditions such that at an instant f(1) the final position of the manipulator 3 in the Cartesian coordinate system in which also the coordinates of the vehicles are specified (obtained via forward kinematics transform p_{fk}) are equal to the position of the vehicle 1, and at an instant f(2), it shall be equal to the position of vehicle 2.

It should be noted that the difference in the last constraint can be different from zero, for instance if the place in vehicle 1 where the workpiece 4 is to be seized on vehicle 1 is different from a reference point of the vehicle identified by its position coordinates x₁. Further, the constraint may apply not only to position components x₁ of the state vector X, but also to velocity components x₂, thus ensuring that the vehicle 1 (or 2) and the manipulator 3 will not only meet somewhere sometime on their trajectories, but will also move at the same speed and in the same direction, so that picking and placing the workpiece 4 can be carried out while both are moving at nonzero speed.

In a first method step S1 of FIG. 2, an initial state X₀ at a time t=0 of the vehicles 1, 2 and the manipulator 3 is defined. Since the movement for which a trajectory is to be determined here will be repeated periodically, a final state X_{Tf} of the system can be assumed to be identical to the initial state X₀; however, this doesn't necessarily mean that the movement of the vehicles 1 and 2 is repetitive with the same cycle period. Rather, periodicity of the operation of the system can be ensured by requiring that whenever a cycle ends by vehicles 1, 2 reaching end points 8, 9 of the trajectories that have been determined for them, other vehicles of the same type be present at the respective starting points 10, 11 of these trajectories.

The constraints of eq. (3) are implemented (S2) by assigning specific numerical values of the robotic units 1, 2, 3 to constants such as qₘᵢₙ, qₘₐₓ, \dot{q}ₘₐₓ and vₘₐₓ, and providing lookup tables or code for evaluating functions such as τₘₐₓ(x₂), fₘₐₓ(x₂).

The cost function J can be chosen (S3) to encode various criteria. Here we consider two cases, namely, motion time (J equaling the time Tf spent by the robotic units 1-3 on their respective trajectories) and energy consumption. Energy consumption can be represented in different ways. Here we chose the integral of power squared as a measure of energy consumption; the cost function may thus be formed of two addends, one representative of time, the other representative of energy consumed by the vehicles and the manipulator:

J=T_{f}+μ(∫ₜ₌₀^{T}^{_{F}}(u₁\dot{q})+∫ₜ₌₀^{T}^{_{F}}(u₂\dot{p})^{T}(u₂\dot{p}))

By choosing an appropriate value for the weighting factor the priority of energy vs cycle time minimization is determined.

Other addends and associated weighting factors can be added to the cost function, for example one considering loads imposed on the manipulator 3, so as to penalize movements where an excessive load, due, e.g., to workpiece 4 being held by the manipulator in an outstretched configuration, is acting on joints of the manipulator and is likely to cause premature wear.

Once the minimization problem has thus been specified completely, conventional numerical methods such as Multiple Shooting and Local Collocation are used for solving it (S4).

In many practical applications, the initial state X₀ and/or the final state X_{Tf} can be determined straightforwardly and unambiguously from practical considerations. For example, if the task of the manipulator is to pick the workpiece from a vehicle in order to deliver it to a workstation, a position in which the manipulator is about to release the workpiece at the workstation can be taken as one or both of these states, since it is a state which the system will inevitably have to go through. In the case considered in FIG. 1, there is no position which the manipulator 3 inevitably has to go through. Therefore, in this case, the initial state X₀ and/or the final state X_{Tf} may be completely undefined for the manipulator 3. Initial or final states may be defined for the vehicles 1, 2 based on some fixed points in space and time, not shown in FIG. 1, where workpieces are loaded and unloaded, or, if times and locations where these receive workpieces from other robotic units are not defined in advance, the minimization problem can be expanded by increasing the number of dimensions of the minimization problem of eq. (3) by the degrees of freedom of these other robotic units.

The method of the invention is applicable any type of tools wielded by the manipulator 3, not only to gripper 12. If the tool is one which actually effects a transformation of the workpiece 4, for example a joining tool such as a riveter, a surface processing tool such as a paint spray nozzle, processing steps are conceivable in which a single vehicle conveys a workpiece to a location in the vicinity of the manipulator where the workpiece is processed by the manipulator while it remains on the vehicle, and the vehicle then conveys the workpiece to a location where a subsequent processing step is carried out, and the locations where the various processing steps are carried out are subject to optimization by the method of the invention. Further, the processing steps wouldn't have to be executed while the vehicle carrying the workpiece is stationary; rather, when no constraint is imposed that during processing, the workpiece must be at rest, minimization of the cost function is likely to produce a result in which, while processing of a workpiece at one manipulator is taking place, the vehicle carrying the workpiece keeps moving towards the location of the next processing step.

### REFERENCE NUMERALS

1 vehicle
2 vehicle
3 manipulator
4 workpiece
5 picking location
6 placing location
7 base
8 end point of trajectory
9 end point of trajectory
10 starting point of trajectory
11 starting point of trajectory
12 gripper

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for trajectory planning in a robotic system comprising:
at least two robotic units;
wherein a state vector of each robotic unit comprises position components and velocity components and is variable with time as a function of input into said each robotic unit and independently from input into every other robotic unit;
wherein a trajectory which defines the motion of said robotic units from an initial state to a final state is determined by finding the trajectory that minimizes a predetermined cost function; and
wherein the cost function is a function of the state vectors of all of said at least two robotic units and is minimized under a constraint which defines a vector difference between at least the position components of the state vectors of said at least two robotic units at an instant of said trajectory.

2. The method of claim 1, wherein said instant is at the end of the trajectory thus determined.

3. The method of claim 1, wherein said instant is determined by minimization of the cost function.

4. The method of claim 3, wherein state vectors of the robotic units at the beginning and at the end of the trajectory are identical.

5. The method of claim 1, wherein the difference is a difference also of velocity components of the state vectors of the robotic units.

6. The method of claim 1, wherein at least one of the robotic units is a vehicle.

7. The method of claim 1, wherein at least one of the robotic units is a manipulator.

8. The method of claim 6, wherein the vehicle, in at least part of its trajectory, carries a workpiece and the manipulator wields a tool for processing the workpiece.

9. The method of claim 1, wherein the cost function increases along with one or more of the following parameters:
time needed for executing the trajectory,
total energy required for executing the trajectory,
peak power required when executing the trajectory, and
load imposed on each one of actuators of the robotic units when executing the trajectory.
